(19) United States
(12) Patent Application Publication
(10) Pub. No.: US 2010/0207730 A1
(43) Pub. Date: Aug. 19, 2010

(54) BEHAVIOURAL METHOD AND DEVICE FOR PREVENTING THE USE OF A CONTACTLESS PORTABLE DEVICE WITHOUT THE BEARER'S AUTHORIZATION

(75) Inventors: Carine Boursier, Aubagne (FR); Pierre Girard, La Destrousse (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, MEUDON (FR)

(21) Appl. No.: 12/675,028

(22) PCT Filed: Aug. 8, 2008
(86) PCT No.: PCT/EP08/60489

§ 371 Date: Mar. 10, 2010

(30) Foreign Application Priority Data
Aug. 27, 2007 (EP) 07301326.0

(51) Int. Cl. H04Q 5/22

(52) U.S. Cl. 340/10.1

(57) ABSTRACT

The invention relates to a method and a device for preventing the establishment of a radiofrequency communication between a contactless portable object and another contactless object. If the bearer of the contactless portable object does not modify the state of at least one on-board sensor of the contactless portable object in a specified manner and in specified proportions, the communication is prevented. One purpose of the invention is to prevent the use of the contactless portable object without the bearer's authorization.

The invention relates to a behavioural method and device for preventing the use of a contactless portable device without the bearer's authorization.

The invention more particularly relates to a method and a device for preventing the establishment of the (radiofrequency) communication between a first contactless portable object and a second contactless object without such first object bearer's authorization.

Some contactless portable objects such as chip cards are operated by a remote power supply. Such supports get the energy required for the operation thereof from an electromagnetic field produced and sent by the card reader with which they have to converse. In addition, such electromagnetic field conveys the data exchanged between the card and the reader during a so-called radiofrequency communication.

Such electromagnetic field is thus necessary and sufficient both for the supply of the chip card and for establishing a communication between the reader and the card.

In any case, the contactless portable objects do not have any link or physical contact with the contactless object which is used as a reader. Such two objects can thus not see each other.

The consequence of this situation is that it is possible to poll a contactless portable object without the bearer thereof (generally the owner thereof) realizing it and/or authorizing such polling, which opens up the way to a new type of attack on contactless portable objects.

This problem exposes contactless portable objects to two main attacks:
invasion of privacy.
fraud.

Invasion of privacy mainly occurs in the field of electronic identity. As a matter of fact, an activation of the contactless portable object (for example an electronic identification card) without the owner's authorization enables a malevolent person to obtain all or part of the information contained in the passport.

Fraud consists in having the electronic portable object carry out a transaction without the owner's authorization, for example, an electronic signature or an authentication or even a payment.

More particularly, it can be considered to use a contactless portable object (for example a card) without the owner's authorization by increasing the distance between a reader and such a card using relays forming a communication bridge between the card and the reader.

For example, if a person owns a contactless payment card, the attacker will take profit of the proximity of an underground station to try to have it pay a transaction without such person knowing it. Therefor, he or she can place the card close to an object which will be used as the reader for the card (for example a modified personal electronic assistant (PGA). From a distance another attacker will place close to the official reader (capable of validating the payment transaction) an object which will be used as the card for the reader (a modified personal electronic assistant (PGA), for example).

When establishing a communication between both PDAs through a Bluetooth, WIFI, or internet connection, for example, it is possible to transmit to the reader the actual communications from the card, and to the card the actual communications from the reader. Then in spite of a big distance which can separate both objects, a pair of attackers can carry out a transaction without the card bearer's authorization.

These problems might be solved by the implementation of the existing solutions.

In the rest of the present description, a particular context of the contactless portable objects, i.e. that of contactless chip cards, will be considered. The contactless object communicating with the card in question will be referred to by the general term of “reader”. Such indications must be considered as an example, and in no way limit the scope of the present invention which remains applicable to all the portable objects which can communicate without contact, such as passports, electronic assistants, wireless phones etc.

To solve the above-mentioned problems, it has already been provided to block the utilization of a contactless card as long as the user thereof does not press a push button provided on such card.

This solution revealed extremely difficult to be implemented while keeping the ISO constraints such as defined in the standards for example ISO standards 7816-1 and ISO 7816-2.

Furthermore, this solution, in addition to high manufacturing costs, generates a significant modification of the reliability of the push button over time.

It has also been provided to prevent an untimely utilization of the card by placing the latter in a metallic case, with the metal having the property of blocking electromagnetic waves.

This solution has major drawbacks in the constraints it entails for the user. As matter of fact, the legal bearer of the card can use it only if he or she takes the card out of the case. This constraint is opposed to the “Tap and Go” philosophy. As a matter of fact “Tap and Go” is a principle according to which a transaction can be integrated in the bearer's natural and fluid movement. The underlying idea is not to force the user to wait.

This aim is reached thanks to very quick transactions for example in the field of transports, with the transactions having to be completed in less than 250 milliseconds. In addition, the transaction must be carried out in a contactless mode, so that the user can use his or her card through a purse, a bag, or a pocket or more particularly so that the user does not have to insert his or her card into a reader.

Then, having to take the card out of a closed case and place it back afterwards obliges the user to “interrupt” his or her movement which is in the contradiction with the above principle.

It has also been provided to oblige the user of a contactless card to present an additional identification element to the reader, such as a secret code, to validate the transaction between the card and the reader. An example is the case of some passports which are read by a contactless reader then which require on the reader's keyboard, the entering of a series number present on the passport body. Then again, this is opposed to the “Tap and Go” principle. In addition, a physical contact between the user and the reader is required then for entering the information in question, which makes this solution close to that of the contactless card and thus reduces the interest of contactless transactions.

In this context, the present invention offers an alternative solution which is the solution to the above-mentioned drawbacks and has its own advantages.

The invention relates to a method and a device for preventing the establishment of a radiofrequency communication between a contactless portable object and another contactless object if the user of the first contactless portable object does not modify the state of at least an onboard sensor of the contactless portable object in a specified manner and in specified proportions.

In the present description and in the following claims, the term “state” will be used to designate one or several physical values which can be measured by one or several sensors existing on or in the card body. Then, the state of an object can designate a position thereof in space and consequently the displacement, temperature, physical structure (torsion) thereof, or any other measurable value.

The term “behaviour” will also be used to designate a measurable variation of a state of an object. This term will be specified by mentioning a “voluntary behaviour” to designate a variation of the state of an object due to a positive action by the bearer thereof.

More precisely, the claimed invention provides for a method intended to prevent the establishment of the radiofrequency communication of a first contactless portable object with a second contactless object without the authorization of the bearer of the first portable object, such method including the steps of:
capture, which consists in capturing a variation in the state of the portable object, also called behaviour.
verification, which consists in the verification of the capture considering a reference value of the behaviour, stored in a memory of the portable object and the production of a similarity index.
decision, which consists in the decision to authorize or not the establishment of the communication if the similarity index produced during the verification step reaches an acceptance level.

Then the invention makes it possible to check that, during the establishment of a radiofrequency communication with the portable object, the bearer of such object is willing to do so.

Therefor, behaviour should be defined to be reproduced by the bearer to prove his or her consent.

In a simple embodiment of the invention, the portable object can contain a simple position sensor which will note whether the object is in vertical or horizontal position.

The expected behaviour can for example be a “changing for a vertical position”. Then, any variation of the sensor stabilized in vertical position will be a behaviour considered as expected.

Measuring a variation in the state and not only a state makes it possible to prevent the case when the object is in a correct state by accident. As a matter of fact if it was sufficient to consider a position of the object in space, if the object is horizontal (because it is laid on a table for example) it would accept any communication without the consent of the owner thereof.

Instead of searching for the position of the object in space, an embodiment consists in analyzing the movement of the object. In this case, the object must be provided with adapted sensors and the object must make a determined movement to authorize the establishment of the communication. In this case, it is preferred to choose a relatively complex movement, so as to prevent it to occur by accident.

Similarly, it is possible to measure the object temperature. For example, if the portable object is a chip card, holding it naturally implies a pressure of the thumb on the surface thereof. Thus, at the point of contact with the finger, the temperature will vary to get close to the body temperature of the finger. If the object includes a correctly calibrated temperature sensor, a variation in the temperature of the object surface (tending for example towards stabilization around 35 degrees Celsius) can be a good certainty index that the bearer holds the card in his or her hand means that is willing to carry out a transaction with his or her card. In an improved embodiment, the body of the object can include several temperature sensors and so the expected behaviour can be a variation tending to stabilization around 35 degrees Celsius, but only of a specified area of the surface.

Another embodiment can be based on a torsion of the whole or a part of the body of the portable object. In this case, the body, or at least a determined area thereof, shall have to include one or several sensors capable of detecting a torsion. The expected behaviour can for example be a torsion at a determined angle in a determined direction.

Whatever the value or values selected to be the behaviour, it is indispensable to have a reference value of such behaviour so as to be able to compare the candidate behaviour.

In a simple embodiment of the invention, this reference behaviour can be recorded beforehand and stored. However, in another embodiment the invention it can be considered that this reference behaviour will not be recorded but calculated. For example, upon each utilization, a screen will describe a behaviour to be adopted and check the validity thereof. It can be considered for example, if the portable object is an electronic assistant that during the solicitation thereof for a radiofrequency communication, the screen will describe a series of movements to be reproduced. With a touch screen it can be considered that the screen will display a pattern to be followed to authorize the transaction.

Now, we have a candidate behaviour and a reference behaviour, and it is necessary to compare these. The methods of comparison depend on the values constituting the behaviours. For example, as regards movements, it is possible to measure the positions of the object, the speed, the amplitude of the movement thereof etc.

When the criteria are defined, the object will produce a similarity index representing the “quality” of the candidate behaviour with respect to the reference behaviour.

If the index reaches a certain level, then the communication is authorized.

In another embodiment, the acceptation threshold may not be defined but calculated. In this case, upon the attempted connection of the reader, the card will apply a calculation function. Such function can for example take into account information resulting from the attempted connection. For example the function can take into account the signal intensity, amplitude, i.e. information which may be emitted during the attempted connection.

Thus, for an attempted connection with a particularly low or particularly fluctuating signal, which can suggest conditions favoring fraud, the level can be very high whereas upon an attempted connection with a strong and stable signal, the acceptance level can be lower.

An additional advantage of the invention is that the behaviour expected by the card can be secret. In this case, the invention provides a higher security level. As a matter of fact, depending on the complexity selected for the behaviour, the invention makes it possible to recreate in a contactless mode, a system which is close to that of the identification code (also called PIN code) which is currently used in the contact mode.

Another advantage of the invention is the possibility of combining behaviours and thus to further increase the security level.

Another advantage of the invention is that it is able to adapt the behaviour to the user. As a matter of fact, depending on the uses, it will be possible to adapt the reference behaviour so that it is as little annoying as possible.

For example, in the case of motion sensor, a natural motion in a 15 years old person is very different from a natural movement in an 85-year old person.

In the particular case of a combination of sensors, it can be considered that some users will use a category of sensors (motion sensors for example) and other users will use another category (pressure sensors for example).

Other characteristics and advantages of the invention will clearly appear when reading the description thereof hereinunder, which is given for information and not as a limitation, and referring to the appended drawings, wherein:

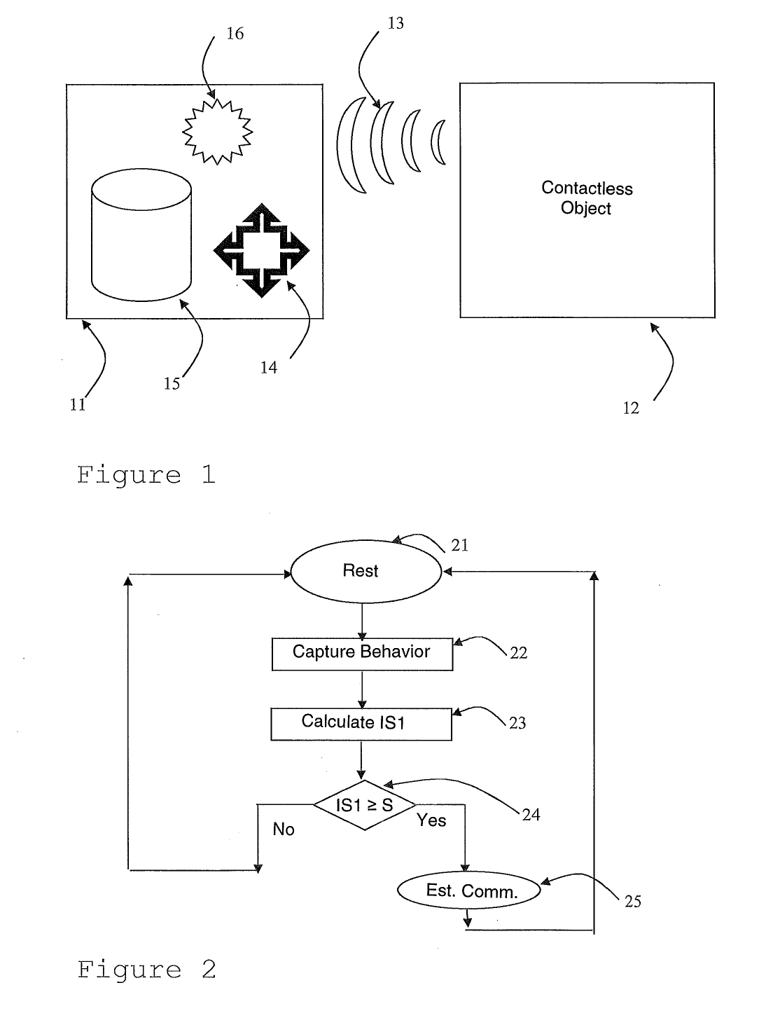

FIG. 1 shows a system wherein a contactless portable object is capable of detecting a modification of the state thereof;

FIG. 2 shows a block diagram of the implementation of the method according to the invention.

FIG. 1 shows a contactless portable object 11 including a sensor 14, a memory 15, and a processor 16.

This figure further shows a contactless object 12 which will be described more precisely hereinunder.

Both objects can communicate through radiofrequency waves 13.

The sensor 14 of the contactless object 11 is capable of measuring a variation in the state of the object 11. Such variation is called behaviour in the present description.

Upon a possible solicitation by the contactless object 12 the contactless object 11 will not accept or establish a connection 13 but if the processor 16 considers that the value read by the sensor and the reference value stored in the memory 15 are similar enough.

In an exemplary implementation of the invention, the contactless portable object is an electronic identification card and such a card is in the pocket of a jacket, in a handbag, or in a purse. In addition, the card includes several accelerometers/inclinometers, forming the sensor 14. The reference behaviour stored in the memory 15 is a horizontal displacement of the card from left to right immediately followed by a horizontal displacement of the card from right to left. The acceptance level is calibrated at a value S. In this example, the function of behaviour comparison takes into account the angles measured by the sensors, the amplitude of the movements, the average speed and instant speeds at precise moments.

Thus, if the card is solicited by a reader without the authorization of the owner thereof (in public transportations for example), the sensors 14 are activated and analyze the movements and the position of the card. It is highly improbable that the card naturally carries out and at that moment, the movement described above. Then the processor will compare the measures of the sensors with the reference. The processor will not find the horizontal position of the card and the left to right displacement only will be noted, not the right to left movement. The step of verification produces a similarity index IS1 in our example.

The step of decision will compare this similarity index IS1 with the predefined level S. In our example the level is not reached and the processor will thus not authorize the establishment of the communication with the reader.

Still in the example, when the card is willingly used, the owner takes the card close to a reader, which results in the activation thereof, and thus the activation of the sensors 14.

Then the user will reproduce the specified behaviour which is a horizontal displacement of the card from the left to the right, immediately followed by a horizontal displacement of the card from the right to the left.

The processor will compare the measures of the sensors with the reference and establish a similarity index. In the case of the example, the sensors recognized the horizontal position of the card and the successive left to right and right to left displacements. The step of verification produces a similarity index IS2 in our example.

The step of decision will compare such similarity index with the predefined level S. As the level is reached, the processor will authorize the establishment of the communication with the reader.

FIG. 2 shows a block diagram of the implementation, in the contactless portable object, of the method according to the invention. This figure shows a step of rest 21, a step of capture of 22 of external information, a step of verification 23, a step of decision 24 as a function of the results from the verification and a step 25 of establishment of a radiofrequency communication.

Upon reception of an attempted radiofrequency communication, a portable object will leave the state of rest 21 to enter another state 22, a state wherein it will capture, via an on-board sensor, a variation in the state also called behaviour. This behaviour can be a movement, a position, a torsion, or any other information likely to be measured on a portable object and that the user can modify willingly. In a particular case of implementation of the invention, this step of capture can have a defined duration, or end when the sensor or the sensors have measured a minimum quantity of information. Upon completion of this step of capture, the portable object will go to a state 23, a state during which it will compare the information noted by the sensor with a reference value. The result of this comparison will be called a similarity index. In a preferred embodiment of the invention such as similarity index is a percentage. Once this similarity index is produced, the portable object will go to a step 24 also called a step of decision. During this step, the portable object will check whether the similarly index reaches a level S. If the level is reached, then the portable object will go to the state 25. Then this state, the portable object will accept the radiofrequency communication and carry out the normally requested transaction.

On the contrary, if during the step 24 the value of the similarity index does not reach the level S, this means that the portable object is not in the expected operation conditions. It can then be assumed that the card is activated without the authorization of the bearer thereof. In this case, the radiofrequency communication can be denied and the object goes back to a standby state 21. In a particular implementation of the invention, after the detection of an activation which is supposed to be without the owner's authorization, the card can make one or several decision(s), for example:
it can record this attempt.
it can decide to accept the communication but in a willingly protected mode. For example while emitting very few information which are not confidential, or emitting only erroneous information.
it can decide to erase the whole or a part of the information it contains.
or have any other reaction.

1. A method for preventing the establishment of a radiofrequency communication of a first contactless portable object with a second contactless portable object without said first object bearer's authorization
comprising the steps of:
capturing a variation of the state of said first portable object, to determine a behaviour;
comparing the captured variation to a reference value of said behaviour stored in a memory of said first portable object, and producing a similarity index.
selectively authorizing the establishment of said communication if the similarity index produced during the comparing step reaches an acceptance level.

2. A method according to claim 1, wherein said behaviour is at least a predefined position in space.

3. A method according to claim 1, wherein said behaviour is at least a movement.

4. A method according to claim 1, wherein said behaviour is at least a variation in temperature.

5. A method according to claim 1, wherein said behaviour is at least a torsion.

6. A method according to claim 1, wherein the acceptance level S is predefined and stored in the memory of the contactless portable object.

7. A method according to claim 1, wherein the acceptance level S is calculated.

8. A method according to claim 1, wherein said first portable object is a contactless chip card.

9. A contactless portable object capable of communicating through a radiofrequency communication with a second contactless object, including at least one sensor of a variation of the state of said first portable object that indicates a behaviour, and a processor which authorizes the establishment of said radiofrequency communication when the similarity between said behaviour captured by said sensor and a reference behaviour stored in the memory of said first portable object reaches a certain level.

10. A portable object according to claim 9, wherein said sensor is a motion sensor.

11. A portable object according to claim 9, wherein said sensor is a temperature sensor.

12. A portable object according to claim 9, wherein said sensor is a torsion sensor.

13. A portable object according to claim 9, wherein said contactless portable object is a contactless chip card.
